(19) United States
(12) Patent Application Publication
(10) Pub. No.: US 2013/0306620 A1
(43) Pub. Date: Nov. 21, 2013

(54) HEATING SYSTEM AND METHODS FOR CONTROLLING THE HEATERS OF A HEATING SYSTEM

(71) Applicants: Sean Timothy Halloran, Denver, CO (US); James Victor Schaefer, Ann Arbor, MI (US)

(72) Inventors: Sean Timothy Halloran, Denver, CO (US); James Victor Schaefer, Ann Arbor, MI (US)

(73) Assignee: PRIMESTAR SOLAR, INC., Arvada, CO (US)

(21) Appl. No.: 13/476,414

(22) Filed: May 21, 2012

(51) Int. Cl. H05B 1/02; G05D 23/19

(52) U.S. Cl. 219/483; 219/485; 219/486; 219/492

(57) ABSTRACT

A method for controlling a plurality of heaters of a heating system is disclosed. The method may generally include generating control commands for turning on the plurality of heaters during a time period, determining which electrical phase is powering each heater of the plurality of heaters and staggering execution of the control commands across the time period for two or more of the heaters powered by the same electrical phase.

### FIELD OF THE INVENTION

The present subject matter relates generally to heating systems having an array of electric heating elements or “heaters” and, more particularly, a method for controlling the heaters of a heating system such that the instantaneous current draws and/or electrical loads on the system may be reduced and/or balanced.

### BACKGROUND OF THE INVENTION

Various manufacturing processes require heating systems for controlling the heating of components conveyed through a chamber with the intent of achieving a uniform temperature profile along the components. An example of such a process is the production of thin film photovoltaic (PV) modules (“panels”), wherein individual glass substrates are conveyed linearly through a pre-heat stage prior to deposition of a thin film layer of a photo-reactive material onto the surface of the substrates.

Conventional heating systems used in industrial equipment typically include a plurality of heaters that are controlled or driven by multiple P, PI, PD or PID control loops. For example, the heaters may be divided into a plurality of individually controlled heater zones, with a single control loop being used to generate control commands for turning ON/OFF each heater zone. Typically, the individual control loops are not coordinated with one another. As such, it is often the case that the instantaneous currents and/or electrical loads for the heating system become imbalanced. For instance, due to the uncoordinated control loops, there may be times at which all or a substantial portion of the instantaneous current draw of the system may be on a single phase, thereby causing an imbalance in the phase current. Such unbalanced electrical loads may lead to blown fuses, higher energy consumption, higher harmonic distortion, unbalanced voltages and/or the like, which may result in higher utility and/or operating costs.

For example, FIG. 8 illustrates a graphical representation of how a conventional heating system is typically configured to execute control commands for a given control loop time period. The heating system includes three heaters (heaters #1, #2 and #3. Additionally, a control command of 20% has been generated for each heater, indicating that each heater is to be turned on for 20% of the control loop time period. As shown in FIG. 8, conventional heating systems are configured to immediately execute the control commands upon the initiation of the control loop time period, thereby turning on all of the heaters at the same time. Thus, assuming that each heater is on the same electrical phase, a substantial imbalance in the phase current may occur.

Accordingly, a system and method in which heaters may be controlled in a manner that reduces the instantaneous current draw on any single phase and/or that balances the electrical loads on the system would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for controlling a plurality of heaters of a heating system. The method may generally include generating control commands for turning on the plurality of heaters during a time period, determining which electrical phase is powering each heater of the plurality of heaters and staggering execution of the control commands across the time period for two or more of the heaters powered by the same electrical phase.

In another aspect, the present subject matter is directed to a heating system including plurality of heaters and a controller in communication with the heaters. The controller may be configured to both generate control commands for turning on the heaters during a time period and determine which electrical phase is powering each heater. In addition, the controller may be configured to stagger execution of the control commands across the time period for two or more of the heaters powered by the same electrical phase.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side, plan view of one embodiment of a heating system in accordance with aspects of the present subject matter;

FIG. 2 illustrates a schematic view of one embodiment of a heater unit of the heating system shown in FIG. 1;

FIG. 3 illustrates a block diagram of one embodiment of a PID controller;

FIG. 4 illustrates a block diagram and associated legend of one embodiment of a PID control loop that may be utilized in accordance with aspects of the present subject matter;

FIG. 5 illustrates a flow diagram of one embodiment of a method for controlling the heaters of a heating system in accordance with aspects of the present subject matter;

FIG. 6 illustrates a graphical representation of one embodiment of how control commands for a plurality of heaters may be divided and staggered across a plurality of time intervals of a predetermined time period;

FIG. 7 illustrates a graphical representation of another embodiment of how control commands for a plurality of heaters may be divided and staggered across a plurality of time intervals of a predetermined time period;

FIG. 8 illustrates a graphical representation of how a conventional heating system is typically configured to execute control commands for a given control loop time period; and

FIG. 9 illustrates a graphical representation of one embodiment of how the execution of the control commands for the heaters shown in FIG. 8 may be staggered across the PID time period in order to prevent phase imbalances.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a heating system and methods for controlling the heaters of a heating system. Specifically, in several embodiments, the execution of control commands for turning on various heaters of the heating system may be staggered across a predetermined time period. As such, the heaters may be rastered in such a way so as to optimize the power delivered to the heaters while at the same time minimizing the peak current on any single phase of the electric power delivered to the heating system over the predetermined time period. In addition, by staggering the execution of the control commands, the current across the electric phases powering the heaters may be leveled or balanced, thereby minimizing phase imbalances.

It should be appreciated that, in general, the disclosed heating system may be configured to form all or part of any suitable industrial equipment used in the heating of articles. However, in several embodiments, the heating system may form all or part of any suitable equipment used in the heating of substrates conveyed through a chamber. For instance, the disclosed heating system may be utilized for heating glass substrates in the production of photovoltaic (PV) modules. Specifically, in a particular embodiment, the heating system may utilized to pre-heat glass substrates being conveyed through a vapor deposition system configured for vapor deposition of a thin film layer (e.g., a film layer of cadmium telluride (CdTe)) onto the glass substrates.

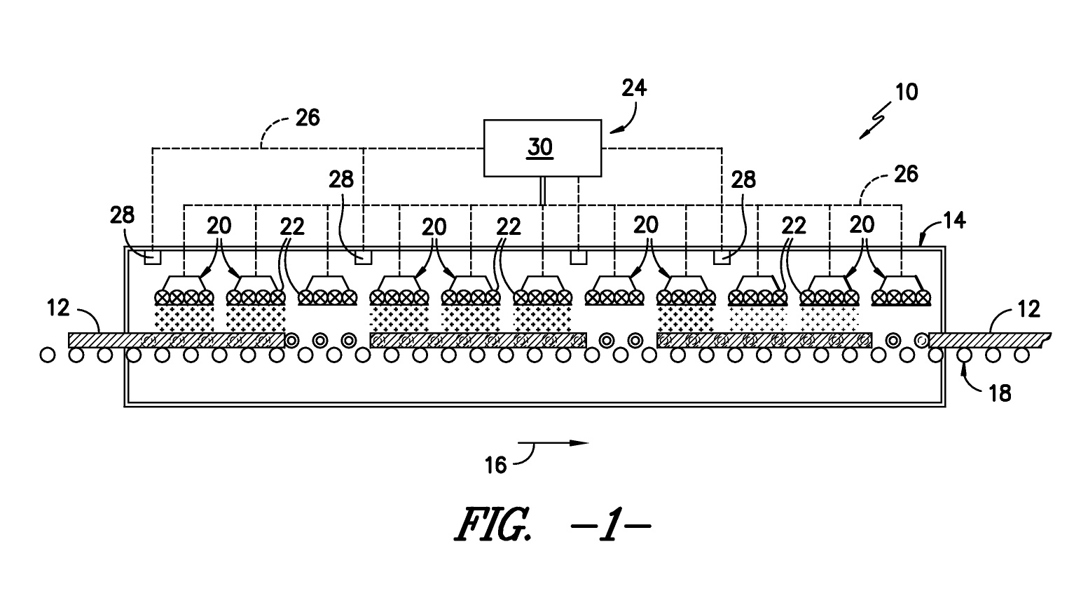

Referring now to the drawings, FIG. 1 illustrates one embodiment of a heating system 10 for heating discrete substrates 12 being linearly conveyed through a chamber 14 along a conveyance direction 16. The substrates 12 may be conveyed through the chamber 14 by any manner of suitable conveyor 18, such as a roller conveyor, belt conveyor, chain conveyor, a combination of separate conveyors and/or the like. In one embodiment, the heating system 10 may be configured such that the conveyor(s) 18 conveys the substrates at a relatively constant speed through the chamber 12. However, in other embodiments, the heating system 10 may be configured to accommodate varying conveyance rates.

It should be appreciated that the present subject matter need not be limited to any particular type of substrate 12 and generally has utility in any manufacturing or processing application wherein it is desired to obtain a uniform temperature profile along discrete, linearly conveyed articles. However, in a particular embodiment, the present subject matter may be particularly well suited for processing glass substrates in a PV module manufacturing system. Moreover, it should be appreciated that the chamber 14 may generally comprise any manner of enclosure that is suitable for temperature-change processing of substrates 12. For example, in one embodiment, the chamber 14 may be a single structure, as shown in FIG. 1, or the chamber 14 may be defined by a plurality of structures or modules that are aligned adjacent to one another in the conveyance direction 16 of the substrates 12.

Additionally, in several embodiments, the heating system 10 may include a plurality of heater units 20 disposed linearly within the chamber 14 along the conveyance direction 16, with each heater unit 20 defining an individual heater zone. The heater units 20 may generally be disposed across the width of the chamber 14 and may be spaced apart from one another so as to apply a relatively uniform temperature treatment to the substrates 12 as they advance through the chamber 14. As shown in FIG. 1, in one embodiment, the heater units 20 may be disposed over the substrates 12. However, in another embodiment, the heater units 20 may be disposed below the substrates 12, such as in an embodiment in which the substrates 12 are conveyed by an overhead conveyer.

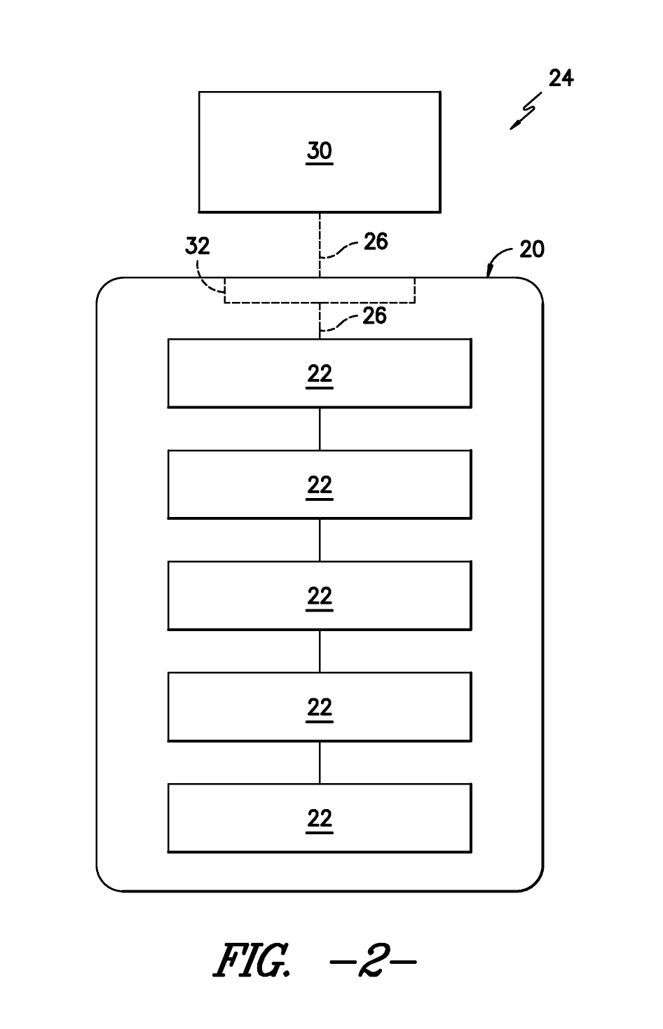

Each heater unit 20 may generally include one or more heater elements or heaters 22. For example, as shown in FIG. 2, in one embodiment, the heater units 20 may include a plurality of heaters 22 wired in series. Alternatively, the heater units 20 may include three heaters 22 in a balanced delta configuration. The individual heaters 22 may generally comprise any suitable type or combination of conventional heating elements. For instance, in several embodiments, the heaters 22 may comprise resistive heaters, quartz lamps, electron beam heaters, lasers and/or the like.

It should be appreciated that, in alternative embodiments, the disclosed heating system 10 need not include a plurality of different heater units 20. For instance, in one embodiment, the heating system 10 may simply include an array of heaters 22 spaced apart from one another within the chamber 14. As such, it should be appreciated that the present subject matter may be applicable to any heating system 10 having an array or plurality of heaters 22.

Referring still to FIGS. 1 and 2, the heating system 10 may also include a controller 24 in communication with each heater unit 20 (e.g., via transmission lines 26) for controlling the operation of the heater units 20 and, thus, the heaters 22. In several embodiments, the controller 24 may be adapted to monitor the temperature within the chamber 14 (e.g., by receiving signals from one or more temperature sensors 28) and, based on such temperature measurements, control each heater unit 20 so as to maintain a steady state temperature within the chamber 14. For example, in one embodiment, the heater units 20 may be individually turned on/off by the controller 24 in order to maintain a desired temperature within the chamber 14. In other embodiments, the controller 24 may be adapted to control the heater units 20 as a function of the spatial position of the substrates 12 within the chamber 14

It should be appreciated that the term “controller” is used generically herein to encompass any manner of hardware and software configured to perform the desired functions described herein. For instance, in several embodiments, the controller 24 may comprise any suitable computer and/or other processing unit. Thus, the controller 24 may include one or more processor(s) and associated memory device(s) configured to perform a variety of computer-implemented functions (e.g., performing the methods, steps, calculations and/or the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of the controller 24 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the controller 24 to perform various functions including, but not limited to, performing PID (Proportional Integral Derivative) calculations within one or more PID control loops, staggering the execution of control commands for turning on/off the heaters 22 and various other suitable computer-implemented functions.

Additionally, the term “controller” may also encompass a combination of computers, processing units and/or related components in communication with one another. Thus, as shown in FIGS. 1 and 2, in several embodiments, the controller 24 may comprise a central system controller 30 in communication with individual sub-controllers 32 associated with each respective heater unit 20, and so forth. In such embodiments, the individual sub-controllers 32 may generally be configured to control the operation of each heater unit 20. For instance, the sub-controllers 32 may comprise individual heater circuits, with each heater circuit including a switch (e.g., a solid zero crossing relay (SSR)) for controlling the supply of power to each heater unit 20. As such, it should be appreciated that controller 24 may be configured to control the heaters 22 of any particular heater unit 20 as a common group (e.g., by turning the heaters 22 of a heater unit 20 on/off together) and/or the controller 24 may be configured to individually control the heaters 22 of each heater unit 20.

It should be appreciated that control of the heater units 20 may be accomplished in various ways. For example, in several embodiments, the controller 24 may utilize a PID (Proportional Integral Derivative) control algorithm to control the operation of the heater units 20. Specifically, in one embodiment, each heater unit 20 may be configured to run on its own PID control loop, such as by configuring each sub-controller 32 to control its corresponding heater unit 20 via a PID control algorithm. As is generally understood, a PID control loop is a generic control loop feedback mechanism that is widely used in processing applications to calculate an “error” as the difference between a measured process value (PV) (e.g., temperature within the chamber 14) and a desired setpoint value (SP) (e.g., a desired steady state temperature within the chamber 14). Thus, utilizing a PID control loop, the controller 24 may be configured to minimize the error by adjusting the process control inputs. PID control loops are commonly used for temperature control in various manufacturing applications.

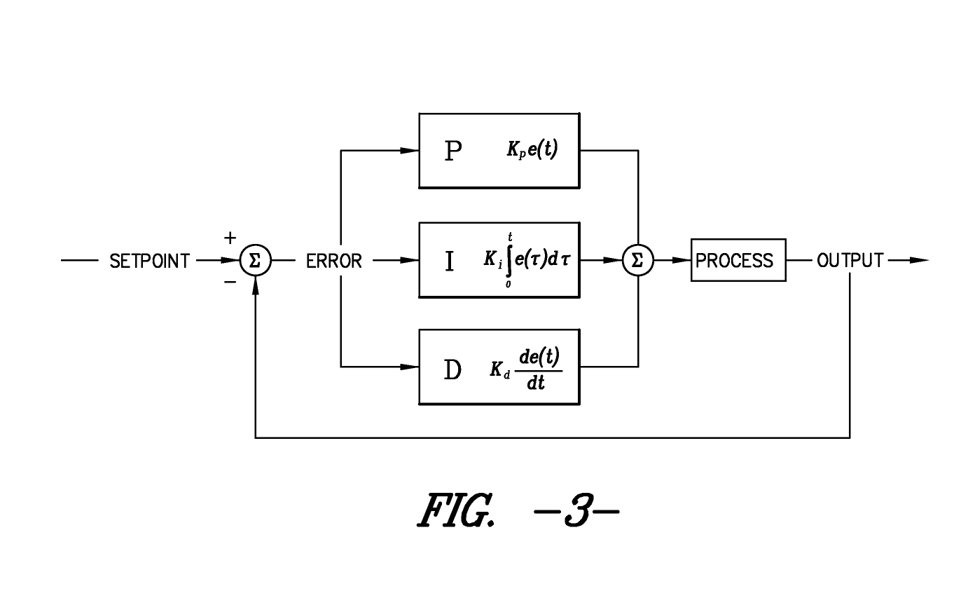

For example, FIG. 3 is a block diagram of a PID control algorithm, which is well known and need not be explained in detail herein. Generally, the PID control algorithm involves three separate parameters: the proportional (P), the integral (I), and the derivative (D) values. These values are combined to provide a controlled variable (CV) output from the PID control loop as a function of time. In the time realm, the proportional (P) value (also called “gain”) makes a change to the CV output that is proportional to the current error value (e(t)) between the setpoint (SP) and process (PV) values multiplied by a tunable proportional gain factor Kₚ:

Pₒᵤₜ=Kₚe(t)

The integral (I) value (also called “reset”) makes a change to the CV output that is proportional to the magnitude and duration of the error by integrating the error over time and multiplying the value by a tunable integral gain factor Kᵢ:

Iₒᵤₜ=Kᵢ∫₀⁴e(τ)dr

The integral (I) term accelerates process towards the setpoint and eliminates the inherent steady-state error that occurs with proportional-only controllers.

The derivative (D) value (also called “rate”) makes a change to the CV output as a function of the slope of the error over time multiplied by a tunable derivative gain factor K_{d}:

$${D}_{out} - {K}_{d} \frac{d}{d t} e ( t )$$

The derivative (D) term slows the rate of change of the controller output and reduces the magnitude of the overshoot produced by the integral (I) term.

The proportional (P), integral (I), and derivative (D) terms are summed to calculate the CV output (u(t))of the PID controller:

$$u ( t ) = MV ( t ) = {K}_{p} e ( t ) + {K}_{i} {\int }_{0}^{t} e ( τ ) d τ + {K}_{d} \frac{d}{d t} e ( t )$$

The control loop is “tuned” to the specific requirements of the process by adjustment of the different gain values (Kp, Ki, Kd) to achieve an optimum control response. Various known methods exist for this “loop tuning.”

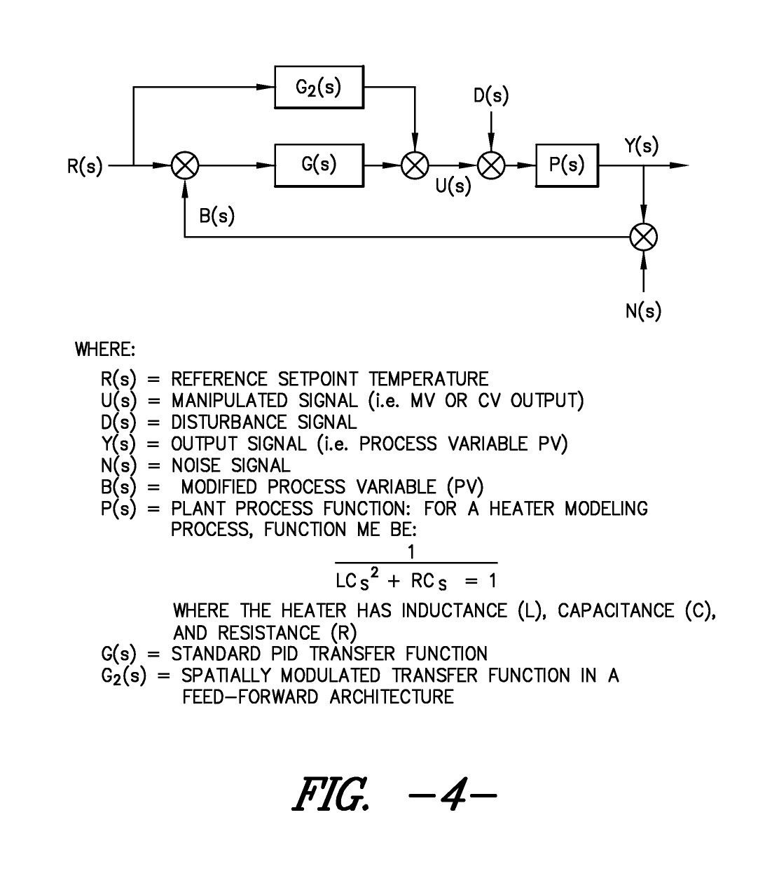

Additionally, FIG. 4 illustrates a block diagram (with legend) of one embodiment of feedback control loop that may be implemented by the controller 24 for controlling the heater units 22 of the disclosed heating system 10. In the particular embodiment shown in FIG. 4, a standard PID control loop may be modulated to accommodate a constant or varying temperature setpoint. Specifically, the standard PID transfer function G(s) may be modified with a spatially modulated transfer function G₂(s) that is triggered by the relative position of the substrates 12 within the processing chamber 14. The spatially modulated transfer function G₂(s) may be, for example, a ramp function that, when triggered, combines with the output of the PID transfer function G(s) to change the manipulated signal U(s) to decrease/increase the CV output (i.e., the output of the heater units 22. It should be appreciated that, in the embodiment shown in FIG. 4, a Laplace transform has been used to transform the PID control algorithm from the time-domain (shown in FIG. 3) to the frequency-domain (shown in FIG. 4).

It should be appreciated that, in several embodiments, the output generated by the PID control loop(s) may comprise individual control commands for turning on/off each heater unit 20. For instance, each sub-controller 32 may be configured to implement a separate PID control loop in order to generate control commands for turning on/off the particular heater unit 20 controlled by such sub-controller 32. In doing so, the sub-controllers 32 may operate on a duty cycle in which PID calculations are performed (and new control commands are generated) at a predetermined update rate. Thus, in several embodiments, each control command may correspond to the percentage of time during the control loop's update period (hereinafter referred to as the “PID time period”) within which each heater unit 20 is to be turned on. For instance, to provide a non-limiting example, the PID time period will be described herein as being equal to one second such that PID calculations are performed (and new control commands are generated) by each sub-controller 32 once every second. Thus, a control command of 25% indicates that a heater unit 20 is to be turned on for 250 milliseconds (ms) during the one second PID time period while a control command of 50% indicates that a heater unit 20 is to be turned on for 500 ms during the one second PID time period. However, it should be appreciated that, in alternative embodiments, the PID time period may generally comprise any suitable update period that may be used with a PID controller, such as a time period of less than one second or a time period of greater than one second.

Additionally, it should be appreciated that the present subject matter need not be limited to any particular type of feedback control mechanism, and thus, the PID control loop described herein is provided only for exemplary purposes. For instance, in alternative embodiments, the heaters 22 may be controlled using multiple P, PI and/or PD control loops.

Referring now to FIG. 5, one embodiment of a method 100 for controlling a plurality of heaters 22 of a heating system 10 is illustrated in accordance with aspects of the present subject matter. As shown, the method 100 generally includes generating control commands for turning on the heaters during a time period 102, determining which electrical phase is powering each heater 104 and staggering execution of the control commands across the time period for two or more of the heaters powered by the same electrical phase 106. It should be appreciated that, although the method elements 102, 104, 106 shown in FIG. 5 are illustrated in a particular order, the elements may generally be performed in any order that is consistent with disclosure provided herein.

In general, the disclosed method 100 may allow for the heaters 22 of a heating system 10 to be rastered in such a way so as to optimize the power delivered to the heaters 22 while at the same time minimizing the peak current on any single phase of the electric power delivered to the system 10 over a specific period of time. In addition, the method 100 may also allow for the current across the electric phases powering the system 10 to be leveled in such a way so as to minimize phase imbalance. As such, instantaneous current draws and electric load imbalances on the heating system 10 may be reduced, thereby minimizing operating costs (e.g., by reducing energy consumption and/or the occurrence of blown fuses) and preventing undesirable operating conditions (e.g., high harmonic distortion and/or unbalanced voltages). Moreover, as will be described below, the disclosed method 100 may be implemented as a control algorithm running within each PID control loop, thereby allowing the instantaneous current to be reduced and/or electrical loads to be balanced without affecting the PID control algorithms implemented by the controller 24 (e.g., via the sub-controllers 32).

As shown in FIG. 5, in 102, control commands may be generated for turning on a plurality of heaters 22 during a time period. As described above, such control commands may be generated by implementing individual PID control loops for each heater unit 22. Thus, in several embodiments, the controller 24 (e.g., via the sub-controllers 32) may generate a control command for each heater unit 20 that indicates a specified percentage of time within which each heater unit 20 is to be turned on during the PID time period. For instance, depending on the difference between the measured and setpoint temperatures for the chamber 14 as well as the potential heat output for each heater unit 20, the controller 24 may be configured to generated control commands for each heater unit 20 in order to maintain a steady state temperature within the chamber 14.

Referring still to FIG. 5, in 104, the particular electric phase powering each heater 22 may be determined. Specifically, in several embodiments, the controller 24 may be configured to determine the electric phase powering each heater 22 included within a heater unit 20 that, based on the generated control commands, is to be turned on during the current PID time period. For instance, in one embodiment, the electric phase powering each heater 22 may be stored within the controller's memory, such as by storing a look-up table with the controller 24 that correlates each heater 22 to the phase(s) powering it. Thus, for each set of control commands generated for a PID time period, the controller 24 may be configured to automatically determine the electric phase powering each heater 22 that is to be turned on during such time period.

It should be appreciated that, in several embodiments, the disclosed heating system 10 may be powered by a three-phase power system. Thus, each heater 22 may be powered by at least one phase of the three phases (e.g., Phase A, B and/or C). For example, for heater units 20 having heaters 22 wired in series, each heater 22 may be powered by the same phase. Similarly, for heater units 20 having heaters 22 arranged in a balanced delta configuration, the heaters 22 may be powered by all three phases. However, it should be appreciated that, in alternative embodiments, the heating system 10 may be powered by a single-phase power system or any other multi-phase power system.

Additionally, as shown in FIG. 5, in 106, the execution of the control commands generated by the controller 24 may be staggered across the PID time period for two or more of the heaters 22 powered by the same electrical phase. Specifically, when multiple heaters 22 powered by the same electric phase are to be turned on during the PID time period, the execution of the control commands for such heaters 22 may be staggered in order to minimize the peak current on such electric phase and to also balance the current across each of the electric phases.

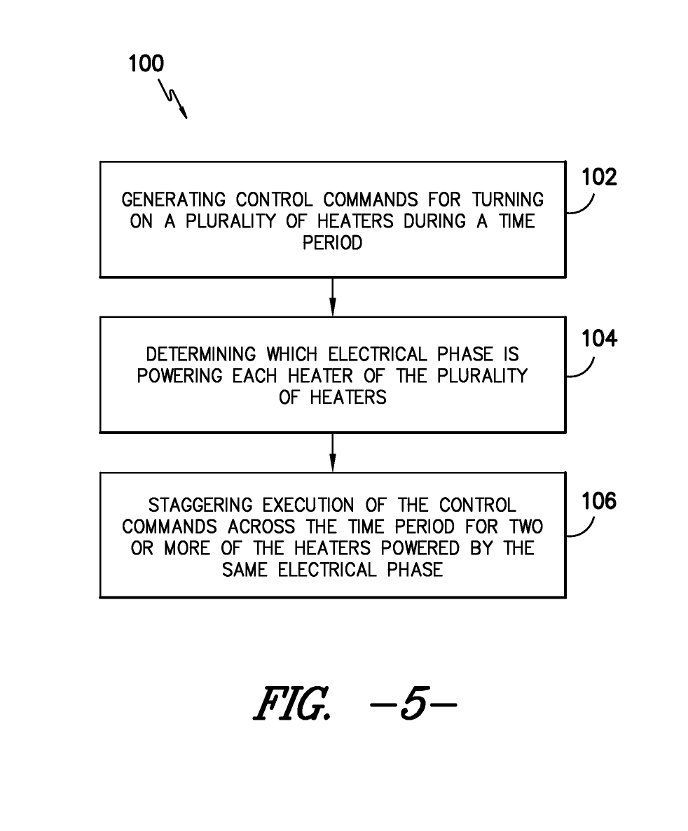

For instance, FIG. 6 provides a time interval chart illustrating one embodiment of how the execution of the control commands for multiple heaters 22 powered by the same electric phase may be staggered across the PID time period. Specifically, FIG. 6 illustrates an embodiment in which seven heaters 22 (powered by the same phase) are to be turned on during a particular PID time period. However, it should be appreciated that application of the present subject may be utilized to stagger the execution of control commands for any suitable number of heaters 22 powered by the same phase.

As shown in FIG. 6, in several embodiments, the PID time period may be divided into a plurality of smaller time intervals, with each time interval corresponding to a fraction of the overall time period. For instance, in the illustrated embodiment, the PID time period is divided into twenty individual time intervals, with each time interval comprising an equal fraction of the PID time period. Thus, for a PID time period of one second, each time interval may comprise a 50 ms time slice of the PID time period. However, it should be appreciated that, in general, the PID time period may be divided into any number of time intervals corresponding to any suitable fraction of the overall time period.

It should be appreciated that the specific number and time span of the time intervals may generally vary depending on the length of PID time period and/or the specific type of heaters 22 being used within the system. For example, some heater types (e.g., quartz lamps) may have a faster response time (i.e., may be able to heat-up faster) than other heater types (e.g., resistive heaters). As such, the length of the time intervals used with a system having heaters with faster response times may be shorter than the time intervals used within a system having heaters with slower response times.

By breaking-up the PID time period into smaller time intervals, the control commands for each heater 22 may be divided over a number of the time intervals such that each control command may be executed across a time interval group (indicated in FIG. 6 by the group of “ON” blocks for each heater 22). For instance, in embodiments in which the time intervals each comprise an equal fraction of the PID time period, each control command may be divided across a number of time intervals corresponding to the percentage of time the heaters 22 are to be turned on during the PID time period. Specifically, as shown in FIG. 6, heater #1 has a control command of 100% and, thus, may be divided across a time interval group spanning the entire PID time period (e.g., by dividing the control command across time intervals #1-#20). Heaters #2 and #3 each have a control command of 50% and, thus, may each be divided across a time interval group spanning half of the PID time period (e.g., by dividing each control command across ten of the time intervals). Similarly, Heaters #4-#7 each have a control command of 25% and, thus, may each be divided across a time interval group spanning 25% of the PID time period (e.g., by dividing each control command across five of the time intervals).

By dividing the control commands into specific time interval groups, the time interval groups may be staggered across the PID time period, thereby allowing the control commands to be executed in a manner that minimizes the current draw for any particular time interval and/or that balances the current draw for any single electric phase during the PID time period. For instance, as shown in FIG. 6, execution of the control commands for Heaters #2 and #3 may be staggered such that Heater #2 is turned on for the first half of the PID time period (e.g., over the first ten time intervals) and Heater #3 is turned on for the second half of the PID time period (e.g., over the last ten time intervals). Similarly, execution of the control commands for Heaters #4-#7 may be staggered so that each heater is turned on over a different 25% section of the PID time period.

As shown in FIG. 6, in several embodiments, the control commands may be divided and staggered across the PID time period such that each control command is fully executed within the time frame defined by the time period. Thus, it should be appreciated that the disclosed method 100 may be executed entirely within the PID control loop(s) implemented by the controller 24, thereby allowing the instantaneous current for each time interval to be reduced and/or electrical loads to be balanced across the PID time period without affecting the PID control algorithms. Specifically, the controller 24 may be configured to perform the PID calculations and, thus, generate the control commands at the initiation of each PID time period (e.g., immediately prior to time interval #1). Thus, as long as each control command has been fully executed by the end of that PID time period (e.g., immediately after time interval #20), the PID control loop may continue to track and control the temperature within the chamber 14 normally. Accordingly, the disclosed method 100 may provide for enhanced operation and efficiency of a heating system 10 without altering its pre-existing temperature control algorithm(s).

It should be appreciated that the manner in which the control commands may be divided into the time interval groups and/or staggered across the PID time period may generally vary depending on the desired operation and/or parameters of the heating system 10. In one embodiment, the control commands may simply be divided into time interval groups and staggered across the PID time period such that a total current draw for each time interval (i.e., the combined current draw for each heater 22 that is turned on during a given time interval) is less than a maximum combined current draw for the particular heaters 22 being controlled. For instance, in the embodiment shown in FIG. 6, if Heaters #1-#7 were all turned on at the beginning of the PID time period (i.e., at time interval #1), the total current draw for each of time intervals #1-#4 would be equal to the maximum combined current draw for the heaters. However, by staggering the execution of the control commands for at least one of the heaters, the total current draw at any one time interval may be less than the maximum combined current draw for the heaters.

In another embodiment, the control commands may be divided into time interval groups and staggered across the PID time period such that a total current draw for each time interval is less than a predetermined current draw threshold. For instance, a current draw threshold may be stored within the controller's memory and/or the controller 24 may be configured to calculate a current draw threshold for each PID time period given the desired operation of the heating system 10. The controller 24 may then be configured to divide and stagger the control commands across the PID time period so that the total current draw for each time interval is at or below the predetermined current draw threshold.

In yet another embodiment, the control commands may be divided into time interval groups and staggered across the PID time period such that the current draw for each time interval is substantially equal to the current draws for the other time intervals. For example, in the illustrated embodiment, assuming that the current draw for Heater #2 is the same as the current draw for Heater #3 and that the current draw for each of Heaters #4-#7 is the same, the control commands have been divided and stagger in FIG. 6 such that the current draw for each time interval is substantially the same.

Additionally, in several embodiments, the controller 24 may be configured to sort or prioritize the control commands based on the full scale current draw of the heater(s) 22 being controlled. For instance, in several embodiments, the controller 24 may be configured to prioritize the control commands according to descending full scale current draws such that the command(s) generated for the heater(s) 22 having the largest full scale current draw(s) is/are assigned the highest weight and the commands(s) generated for the heater(s) 22 having the smallest full scale current draw(s) is/are assigned the lowest weight. In such embodiments, the controller 24 may be configured to stagger the control commands with the highest weight first, thereby ensuring that the largest current draws are balanced across the PID time period.

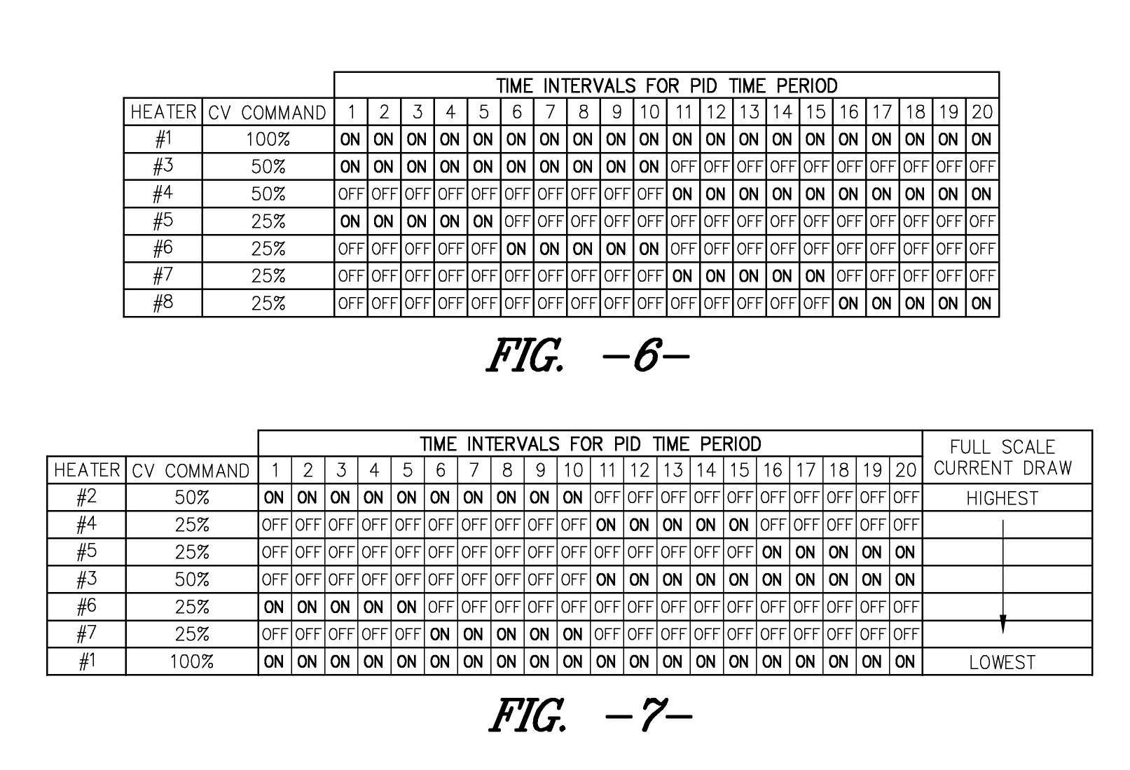

For instance, FIG. 7 illustrates the time interval chart shown in FIG. 6 in which the control commands have been sorted and staggered based on the full scale current draws of their corresponding heaters (i.e., Heaters #1-#7). Specifically, the control commands have been sorted according to descending full scale current draws such that the control commands generated for the heaters 22 with highest full scale current draws are prioritized first when staggering the commands. For instance, as shown, Heaters #2, #4 and #5 have the highest full scale current draws and, thus, their corresponding control commands have been added first to the time interval chart and staggered across the PID time period. The control commands for the heaters with the lower full scale current draws (i.e., Heaters #3, #6, #7 and #1) may then be divided and staggered across PID time period so as to minimize the current for any particular time interval and/or balance the current draw for the electric phase during the PID time period.

It should be appreciated that, in alternative embodiments, the staggering of the execution of the control commands may be prioritized in any other suitable manner. For instance, the control commands may be prioritized according ascending full scale current draws and/or according to any other suitable operating condition/parameter of the heating system 10 (e.g., by prioritizing the control commands according to descending/ascending heat outputs for the heaters 22).

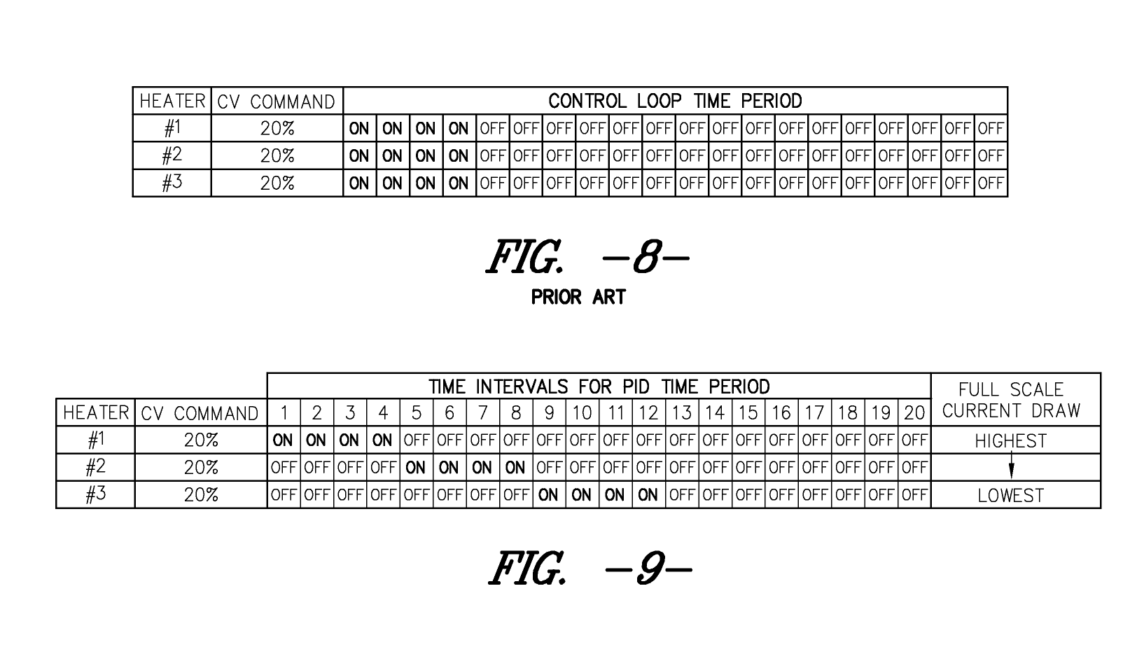

Referring now to FIG. 9, a time interval chart is provided that illustrates one embodiment of how the execution of the control commands for the heaters shown in FIG. 8 may be staggered across the PID time period in accordance with the disclosure provided herein. Specifically, instead of immediately executing the 20% control commands at the initiation of the PID time period (as shown in FIG. 8), the control commands for each heater may be divided into the time interval groups and/or staggered across the PID time period. As such, only one heater is turned on at any given time within the PID time period, thereby minimizing phase imbalance. Moreover, similar to the embodiment described above with reference to FIG. 7, the heaters may be prioritized by their full scale current draw to further even out the instantaneous current draw. For instance, in the embodiment shown in FIG. 9, the full scale current draw for heater #1 may be equal to or greater than the full scale current draw for heater #2 and the full scale current draw for heater #2 may be equal to or greater than the full scale current draw for heater #3.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for controlling a plurality of heaters of a heating system, the method comprising:
generating control commands for turning on the plurality of heaters during a time period;
determining which electrical phase is powering each heater of the plurality of heaters; and
staggering execution of the control commands across the time period for two or more of the heaters powered by the same electrical phase.

2. The method of claim 1, wherein the time period comprises a plurality of time intervals, further comprising dividing the control command for each heater across a number of the time intervals such that each control command is executed across a time interval group.

3. The method of claim 2, wherein staggering execution of the control commands across the time period for two or more of the heaters powered by the same electrical phase comprises staggering the time interval groups for each of the two or more heaters across the time period.

4. The method of claim 3, wherein staggering the time interval groups for each of the two or more heaters across the time period comprises staggering the time interval groups such that a current draw for each time interval is less than a predetermined current draw threshold.

5. The method of claim 3, wherein staggering the time interval groups for each of the two or more heaters across the time period comprises staggering the time interval groups such that a current draw for each time interval is less than a maximum combined current draw for the two or more heaters.

6. The method of claim 3, wherein staggering the time interval groups for each of the two or more heaters across the time period comprises staggering the time interval groups such that a current draw for each time interval is substantially the same as the current draw for the other time intervals.

7. The method of claim 1, further comprising prioritizing the control commands based on a full scale current draw for each of the two or more heaters.

8. The method of claim 7, wherein prioritizing the control commands based on a full scale current draw for the two or more heaters comprises prioritizing the control commands such that the control commands with the largest full scale current draws are staggered first.

9. The method of claim 1, wherein generating control commands for turning on a plurality of heaters during a time period comprises generating the control commands with a controller using at least one PID control loop.

10. The method of claim 9, wherein the time period comprises a PID time period for the at least one PID control loop.

11. A heating system, comprising:
a plurality of heaters; and
a controller in communication with the plurality of heaters, the controller being configured to both generate control commands for turning on the plurality of heaters during a time period and determine which electrical phase is powering each heater of the plurality of heaters,
wherein the controller is further configured to stagger execution of the control commands across the time period for two or more of the heaters powered by the same electrical phase.

12. The system of claim 11, wherein the time period comprises a plurality of time intervals, wherein the controller is further configured to divide the control command for each heater across a number of the time intervals such that each control command is executed across a time interval group.

13. The system of claim 12, wherein the controller is configured to stagger the time interval groups across the time period such that a current draw for each time interval is less than at least one of a predetermined current draw threshold or a maximum combined current draw for the two or more heaters.

14. The system of claim 12, wherein the controller is configured to stagger the time interval groups across the time period such that a current draw for each time interval is substantially the same as the current draw for the other time intervals.

15. The system of claim 11, wherein the controller is further configured to prioritize the control commands based on a full scale current draw for each of the two or more heaters.

16. The system of claim 15, wherein the control commands are prioritized according to descending full scale current draws.

17. The system of claim 11, wherein the controller is configured to generate the control commands using at least one PID control loop.

18. The system of claim 17, wherein the time period comprises a PID time period for the at least one PID control loop.

19. The system of claim 11, wherein each control command corresponds to a percentage of the time period within which at least one of the heaters is to be turned on.

20. The system of claim 11, wherein the controller comprises a plurality of sub-controllers, each of the plurality of sub-controllers being configured to control the operation of at least one of the plurality of heaters.
